(19) United States
(12) Patent Application Publication
(10) Pub. No.: US 2023/0418597 A1
(43) Pub. Date: Dec. 28, 2023

(54) CALL GRAPH GENERATION APPARATUS, CALL GRAPH GENERATION METHOD AND PROGRAM

(71) Applicant: NIPPON TELEGRAPH AND TELEPHONE CORPORATION, Tokyo (JP)

(72) Inventor: Takuya IWATSUKA, Tokyo (JP)

(21) Appl. No.: 18/254,739

(22) PCT Filed: Dec. 11, 2020
(86) PCT No.: PCT/JP2020/046243

§ 371 Date: May 26, 2023

(51) Int. Cl. G06F 8/75; G06F 8/36

(52) U.S. Cl. CPC G06F 8/75; G06F 8/36

(57) ABSTRACT

A call graph creation apparatus includes a first identification unit configured to analyze a definition of a first function included in a certain program and to identify a list of classes instantiated in the first function and a list of second functions called by the first function, a second identification unit configured to identify, for each of the second functions, a class including a definition of the second function from the list of the classes, and a creation unit configured to set each of the first function and the second functions as a node and to generate a call graph including an edge from a node of the first function to a node of each second function, thereby improving call graph creation accuracy.

### TECHNICAL FIELD

The present invention relates to a call graph creation apparatus, a call graph creation method, and a program.

### BACKGROUND ART

A call graph of a program is a directed graph having a function in the program as a node. When another function is called during processing of a certain function, the calling relation is represented as an edge from a node of the calling function to a node of the called function in a call graph. Since a call graph can be used to trace a flow of program processing, the call graph is widely used as a program analysis means.

A class-based object-oriented programming language in which functions are defined in association with classes often has a function called class inheritance. A class (child class) of an inheritance destination has a function of the same interface as a class (parent class) of an inheritance source, and processing of the function can be overwritten. In a program described in a programming language having inheritance as a function, classes having an inheritance relation therebetween have functions of the same interface, and thus it may be impossible to determine which class defines a function to be called by calling a function at a certain point until the program is executed.

When a calling relation between functions cannot be uniquely determined at the time of creating a call graph by analyzing a program, it is possible to create a call graph covering all call relations that may be obtained by analyzing an inheritance relation between classes (call hierarchy analysis (CHA)) and creating an edge for nodes of all functions that may be called.

In creation of a call graph by CHA, a call graph is created only according to the class inheritance relation, and thus a call relation which cannot occur in actual execution of a program is likely to appear in the graph. This reduces the accuracy of software analysis using a call graph.

For example, a case in which there are classes B and C inheriting a class A, as shown in FIG. 1, and a call graph from a function f of class Z shown in FIG. 2 is created by CHA may be conceived.

In the example shown in FIG. 2, an imaginary programming language is used. Z, A, and B define classes, f and g define functions, and it is assumed that the inside of the function has the same syntax and meaning as those of Java (registered trademark).

Since the function g is a function for receiving an object of the class A or a class inheriting the class A although an object transferred to the function g called from the function f is actually an instance of the class B, the class of the actually transferred object is ignored and a call graph as shown in FIG. 3 is created in CHA. This call graph includes a call A.x or C.x which does not occur when an actual program is executed.

In order to solve this, there is a conventional technology (Non Patent Literature 1) called rapid type analysis (RTA). In RTA, classes instantiated in a function are recorded by analyzing source code of the function, and functions which may be actually called by function calling at a certain point are narrowed down. Thus, the accuracy of software analysis using the call graph can be improved. When a call graph is created by RTA in the above-described example, a call graph as shown in FIG. 4 is created using an analysis result that a class instantiated in a function f is B.

### CITATION LIST

### Non Patent Literature

[NPL 1] David F. Bacon and Peter F. Sweeney, “Fast static analysis of C++ virtual function call,” SIGPLAN Not. 31, 10 (October 1996), 324-341, [online] Internet<URL: https://doi.org/10.1145/236338.236371>

### SUMMARY OF INVENTION

### Technical Problem

However, since a call graph is created using a list of classes instantiated in a function itself that Performs function calling or a calling function of the function that performs function calling in RTA, the call graph cannot be created when processing of instantiating classes is performed outside the calling relation of the functions.

When an instance of another class Y is required in order to generate an instance of a certain class X, the class X has a relation depending on the class Y, which is called a dependency relation between classes. In a large-scale program, a dependency relation between classes is complicated, and thus a design pattern called a “dependent injection (DI)” which manages instantiation processing independently of a processing flow of the program is utilized. In implementation using DI, it is general to obtain an object generated through DI from an object called a DI container. As an example, source code obtained by rewriting the above-mentioned example using DI is shown in FIG. 5.

In FIG. 5, an object container of a class Container of the DI container holds instances generated through the DI, and generation of instances through DI is performed independently of the flow of function call by a library providing the DI function. Therefore, in RTA, it is impossible to know which class has an instance corresponding to an object to be substituted into a of the function f, and thus it is not possible to create a call graph.

Further, generation of instances through DI may be performed using a dynamic function of a programming language such as reflection, and this problem cannot be solved with only the conventional method of recording classes instantiated in source code.

In view of the aforementioned circumstances, an object of the present invention is to improve call graph creation accuracy.

### Solution to Problem

In order to solve the above problem, a call graph creation apparatus includes a first identification unit configured to analyze a definition of a first function included in a certain program and to identify a list of classes instantiated in the first function and a list of second functions called by the first function, a second identification unit configured to identify, for each of the second functions, a class including a definition of the second function from the list of the classes, and a creation unit configured to set each of the first function and the second functions as a node and to generate a call graph including an edge from a node of the first function to a node of each second function.

### Advantageous Effects of Invention

It is possible to improve call graph creation accuracy.

### BRIEF DESCRIPTION OF DRAWINGS

FIG. 1 is a diagram showing an example of an inheritance relation between classes and a function of each class.

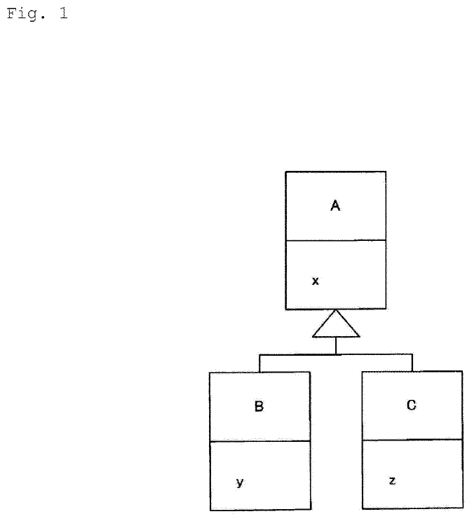

FIG. 2 is a diagram showing an example of source code for calling a function of a class.

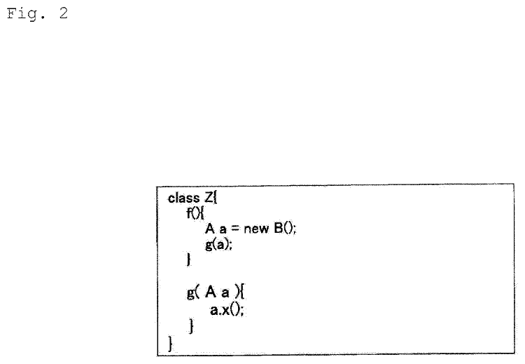

FIG. 3 is a diagram showing an example of a call graph created by CHA.

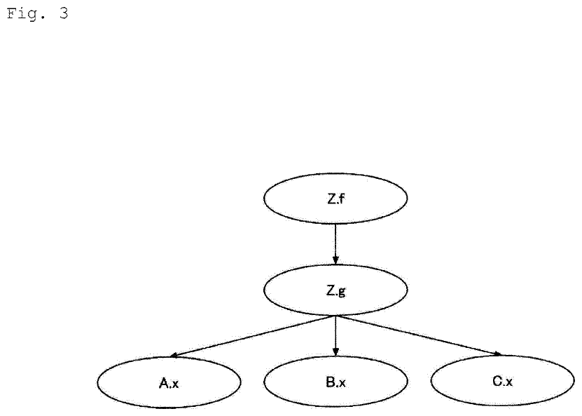

FIG. 4 is a diagram showing an example of a call graph created by RTA.

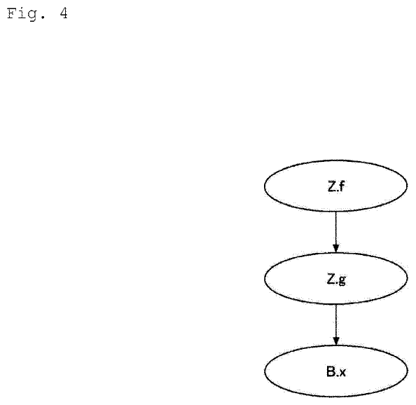

FIG. 5 is a diagram showing an example of source code rewritten using DI.

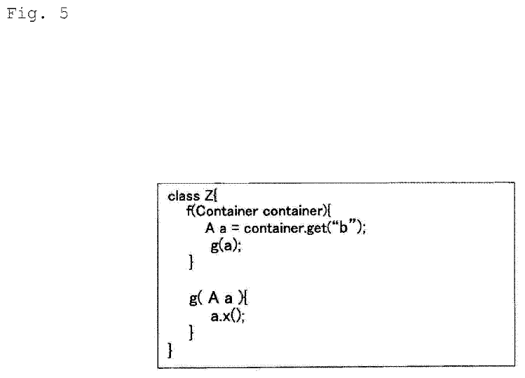

FIG. 6 is a diagram showing an example of a hardware configuration of a call graph creation apparatus 10 in an embodiment of the present invention.

FIG. 7 is a diagram showing an example of a functional configuration of the call graph creation apparatus 10 in an embodiment of the Present invention.

FIG. 8 is a flowchart illustrating an example of a processing procedure executed by a DI setting file analysis unit 11.

FIG. 9 is a flowchart illustrating an example of a processing procedure executed by a DI annotation analysis unit 12.

FIG. 10 is a flowchart illustrating an example of a processing procedure executed by a DI defined function analysis unit 13.

FIG. 11 is a flowchart illustrating an example of a processing procedure executed by a call graph creation unit 14.

FIG. 12 is a flowchart illustrating an example of a processing procedure of class identification Processing.

### DESCRIPTION OF EMBODIMENTS

A call graph creation device apparatus 10 disclosed in the present embodiment analyzes a certain program (hereinafter referred to as a “target program”) implemented in a class-based object-oriented programming language such as Java (registered trademark) and outputs a call graph of the target program.

In a program implemented using dependency injection (DI), class instantiation is performed independently of a flow of processing of the program. In the case of using DI, it is general to use a dedicated library, and as methods of instantiating classes in such a library, a method of instantiating classes according to description of a function in a program, a method of instantiating classes according to description of a setting file, and a method of instantiating classes according to annotations applied to classes are used.

For a problem that an accurate call graph cannot be created by a conventional call graph creation technology, the call graph creation apparatus 10 statically analyzes a class to be instantiated before creation of a call graph and uses an analysis result for class identification at the time of creation of the call graph to solve this problem.

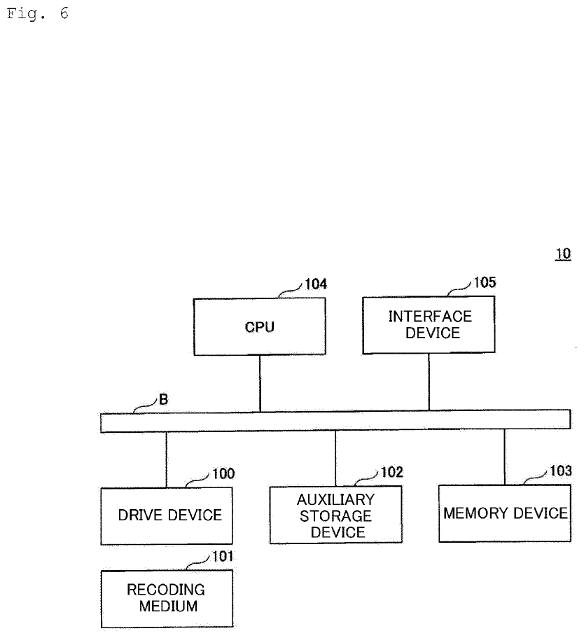

Hereinafter, an embodiment of the present invention will be described with reference to the accompanying drawings. FIG. 6 is a diagram showing an example of a hardware configuration of the call graph creation apparatus 10 according to an embodiment of the present invention. The call graph creation apparatus 10 in FIG. 6 includes a drive device 100, an auxiliary storage device 102, a memory device 103, a CPU 104, an interface device 105, and the like, which are connected via a bus B.

A program that realizes processing performed in the call graph creation apparatus 10 is provided on a recording medium 101 such as a CD-ROM. When the recording medium 101 storing the program is set in the drive device 100, the program is installed from the recording medium 101 to the auxiliary storage device 102 via the drive device 100. However, the program does not necessarily have to be installed from the recording medium 101 and may be downloaded from another computer via a network. The auxiliary storage device 102 stores the installed program as well as necessary files, data, and the like.

The memory device 103 reads the program from the auxiliary storage device 102 and stores the program when an instruction for starting the program is issued. The CPU 104 executes functions of the call graph creation apparatus 10 according to the program stored in the memory device 103. The interface device 105 is used as an interface for connection to a network.

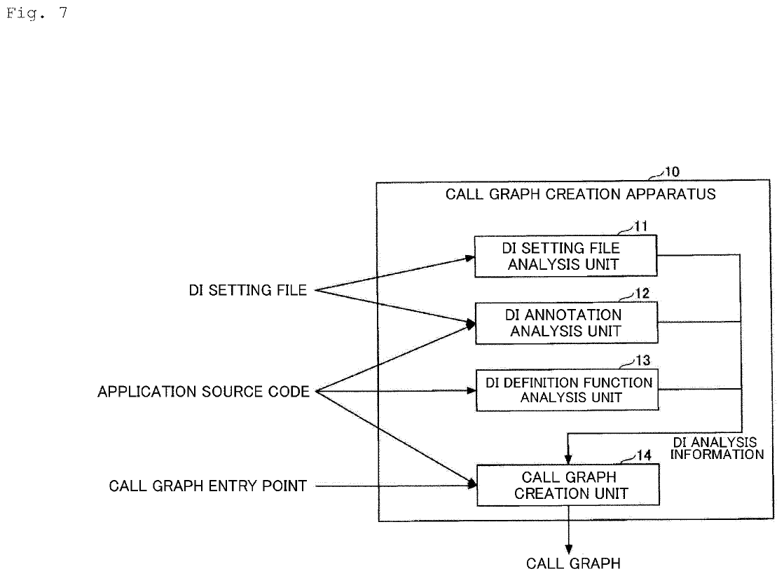

FIG. 7 is a diagram showing an example of a functional configuration of the call graph creation apparatus 10 in an embodiment of the present invention. In FIG. 7, the call graph creation apparatus 10 includes a DI setting file analysis unit 11, a DI annotation analysis unit 12, a DI definition function analysis unit 13, and a call graph creation unit 14. These units are realized through processing caused to be executed by the CPU 104 by one or more programs installed in the call graph creation apparatus 10.

The DI setting file analysis unit 11 identifies a list of classes to be instantiated when a target program is executed by analyzing a DI setting file.

The DI annotation analysis unit 12 identifies a list of classed to be instantiated when the target program is executed by analyzing classes to which DI annotation has been applied.

The DI definition function analysis unit 13 identifies a list of classes to be instantiated when the target program is executed by analyzing a DI definition function.

The call graph creation unit 14 creates a call graph using analysis results (lists of classes) output from the DI setting file analysis unit 11, the DI annotation analysis unit 12, and the DI definition function analysis unit 13. The call graph is a directed graph in which a function in the program is a node and a call relation of the function is an edge.

Hereinafter, details and operation of each unit will be described in detail.

[DI Setting File Analysis Unit 11]

The DI setting file analysis unit 11 reads a DI setting file for a target program and analyzes classes to be instantiated by a library having a DI function. Although the DI setting file has different formats depending on use for DI, it is composed of information described below. The following notation is based on the BNF notation.
DI setting file::=DI setting list DI annotation search target class identifier *
DI setting list::=DI setting *
DI setting::=DI setting identifier Class identifier Property setting*
Property setting::=Property identifier Value|property identifier DI setting identifier

The DI annotation search target class identifier is an identifier (hereinafter referred to as a “class identifier”) that can uniquely identify a class (hereinafter referred to as a “annotation search target class”) that is a DI annotation search target (search range) when a library having the DI function generates an instance using DI annotation. DI setting is setting including a class identifier of a class instantiated by the library having the DI function. Property setting is setting for designating a value to be set to the property of an instance or an object (DI setting identifier) when the library having the DI function generates the instance.

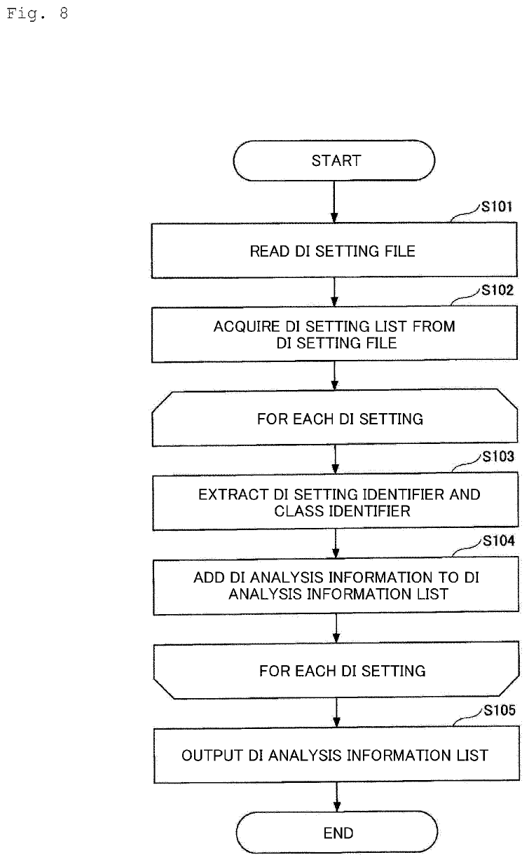

FIG. 8 is a flowchart illustrating an example of a processing procedure executed by the DI setting file analysis unit 11.

In step S101, the DI setting file analysis unit 11 reads a DI setting file for a target program. Subsequently, the DI setting file analysis unit 11 acquires a DI setting list from the DI setting file by performing syntax analysis of the DI setting file (S102). Subsequently, the DI setting file analysis unit 11 extracts a set of a DI setting identifier and a class identifier included in corresponding DI setting for each DI setting included in the DI setting list (S103), and adds DI analysis information including the extracted DI identifier and class identifier to a DI analysis information list (S104). The DI analysis information and the DI analysis information list are as follows.
DI analysis information::=DI setting identifier Class identifier
DI analysis information list::=DI analysis information*

Subsequently, the DI setting file analysis unit 11 outputs the DI analysis information list (S105).

[DI Annotation Analysis Unit 12]

The DI annotation analysis unit 12 is a module for analyzing a class instantiated by a library having the DI function by analyzing classes to which DI annotation has been applied.

Although DI annotation has different formats depending on use for DI, it is generally implemented using an annotation function of a programming language, and a class to which DI annotation has been applied indicates a target of instantiation by DI. A DI setting identifier is set to DI annotation.

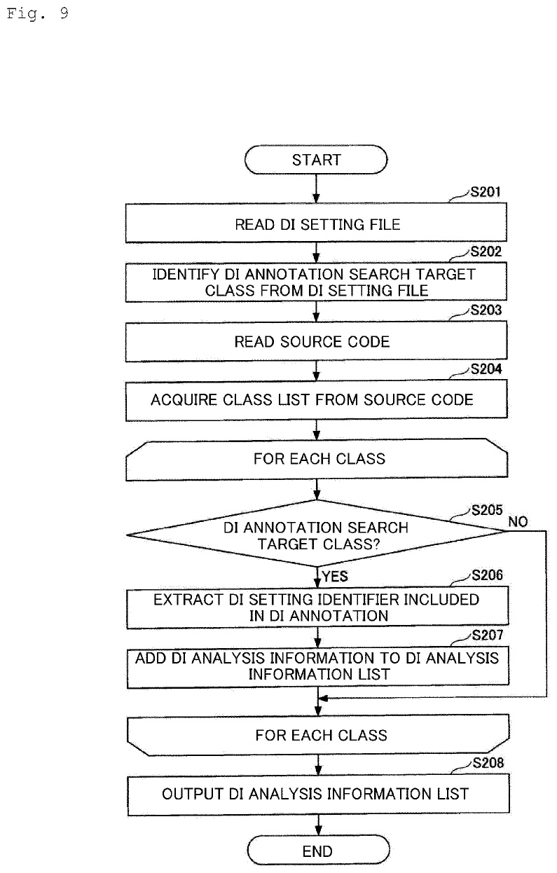

FIG. 9 is a flowchart illustrating an example of a processing procedure executed by the DI annotation analysis unit 12.

In step S201, the DI annotation analysis unit 12 reads a DI setting file. Subsequently, the DI annotation analysis unit 12 acquires a DI annotation search target class identifier by performing syntax analysis of the DI setting file, thereby identifying a class (DI annotation search target class) relating to the DI annotation search target class identifier (S202).

Subsequently, the DI annotation analysis unit 12 reads the source code of a target program (S203) and performs syntax analysis on the source code to acquire a class list (S204). The class list is a list of class identifiers of respective classes used by the target program.

Subsequently, the DI annotation analysis unit 12 determines whether or not the corresponding class corresponds to any DI annotation search target class (that is, whether or not the class identifier of the corresponding class matches the class identifier of the DI annotation search target class) for each class relating to class identifiers included in the class list (S205), and if the corresponding class corresponds to any DI annotation search target class (YES in S205), searches for DI annotation from the definition of the corresponding class and extracts a DI setting identifier included in the DI annotation (S206). The DI annotation analysis unit 12 adds DI analysis information including the extracted DI setting identifier and the class identifier of the corresponding class to DI analysis information list (S207). The DI analysis information list is generated separately from the DI analysis information list extracted by the DI setting file analysis unit 11.

Subsequently, the DI annotation analysis unit 12 outputs the DI analysis information list (S208).

[DI Definition Function Analysis Unit 13]

The DI definition function analysis unit 13 is a module for analyzing a DI definition function and analyzing a class instantiated by a library having the DI function. The DI definition function generally uses a function definition function of a programming language, and allows a DI container to hold an object instantiated in the function by applying an annotation indicating the DI definition function or by using an API of a library having the DI function. A DI setting identifier is set to the DI definition function.

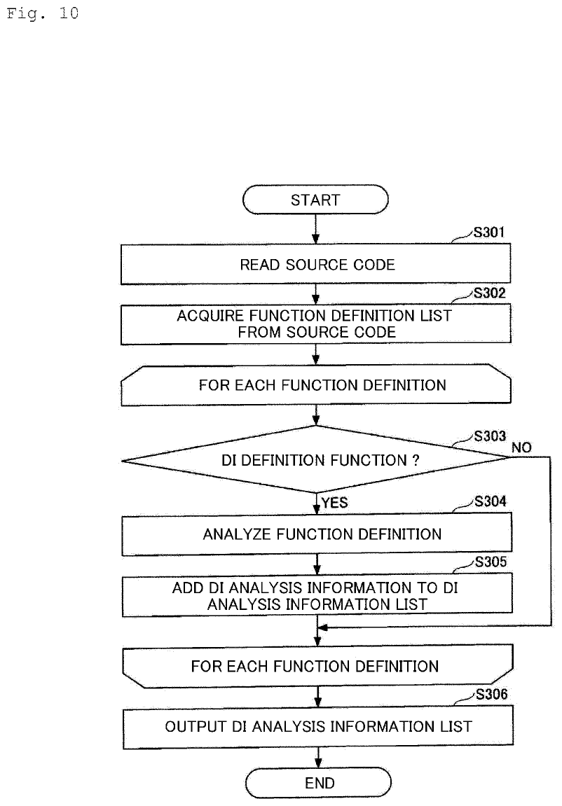

FIG. 10 is a flowchart illustrating an example of a processing procedure executed by the DI definition function analysis unit 13.

In step S301, the DI definition function analysis unit 13 reads the source code of the target program. Subsequently, the DI definition function analysis unit 13 acquires a function definition list by performing syntax analysis of the source code (S302). The function definition list is a list of definitions of functions (functions (methods) of classes) used by the target program.

Subsequently, the DI definition function analysis unit 13 determines whether or not a function according to corresponding function definition is a DI definition function (S303) by checking whether an annotation indicating a DI definition function is applied or an API for the DI definition function is used for each function definition included in the function definition list (S303), and if the function is a DI definition function (YES in S303), analyzes the corresponding function definition (S304). Specifically, the DI definition function analysis unit 13 acquires a return value of the function according to the function definition and identifies a point at which the return value is instantiated in the function definition, thereby extracting a class identifier of a class of the return value from the function definition. That is, the class is identified as a class to be instantiated by a library having the DI function. The DI definition function analysis unit 13 extracts a DI setting identifier from the function definition by analyzing the annotation indicating a DI definition function or the API for the DI definition function in the function definition. The DI definition function analysis unit 13 adds DI analysis information including the extracted DI identifier and the class identifier of the return value to the DI analysis information list (S305).

Subsequently, the DI definition function analysis unit 13 outputs the DI analysis information list (S306).

[Call Graph Creation Unit 14]

The call graph creation unit 14 is a module for creating a call graph on the basis of the DI analysis information output from the DI setting file analysis unit 11, the DI annotation analysis unit 12, and the DI definition function analysis unit 13 and the source code of the target program.

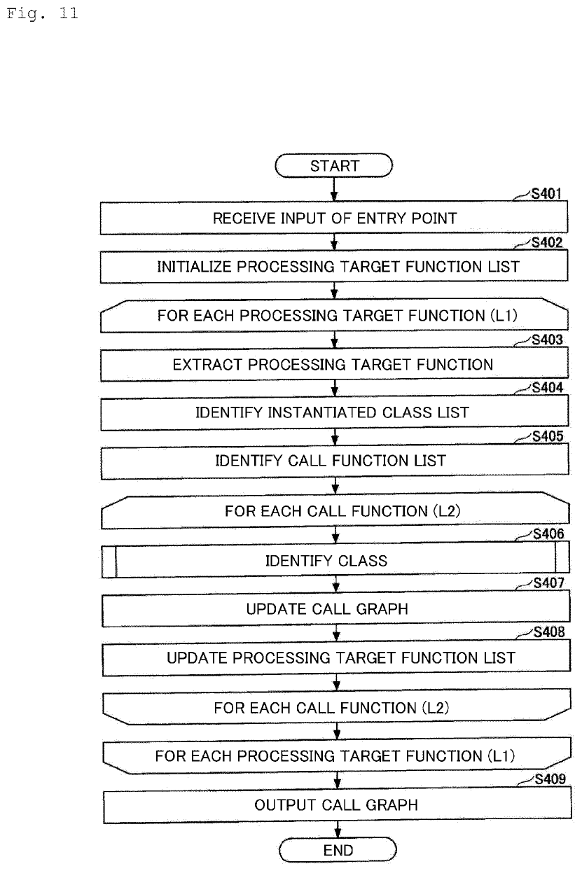

FIG. 11 is a flowchart illustrating an example of a processing procedure executed by the call graph creation unit 14.

In step S401, the call graph creation unit 14 receives an input of identifiers (function identifiers) of one or more call graph entry points from a user. A call graph entry point is a function (any function (method) of any class of the target program) serving as a starting point of a call graph to be created. Function identifiers of a plurality of call graph entry points may be input.

Subsequently, the call graph creation unit 14 sets one or more function identifiers input as call graph entry points as initial values of a processing target function list (S402). Subsequently, the call graph creation unit 14 executes loop processing L1 including steps S403 to S405 and loop processing L2 for each processing target function included in the processing target function list.

In step S403, the call graph creation unit 14 extracts one processing target function from the processing target function list. Hereinafter, the extracted processing target function is referred to as a “processing target function X.” The extracted processing target function X is deleted from the processing target function list.

Subsequently, the call graph creation unit 14 extracts a list of class definitions of classes (hereinafter referred to as “instantiated classes”) instantiated in the processing target function X by analyzing the definition (source code) of the processing target function X (S404). That is, the call graph creation unit 14 identifies a list of instantiated classes.

Subsequently, the call graph creation unit 14 extracts a list of function identifies (hereinafter referred to as a “call function list”) of respective functions (hereinafter referred to as “call functions”) called in the processing target function X by analyzing the definition of the processing target function X (S405). That is, the call graph creation unit 14 identifies a call function list.

Subsequently, the call graph creation unit 14 executes loop processing L2 including steps S406 to S408 for each function (call function) relating to a function identifier included in the call function list. A call function that is a processing target in loop processing loop L2 is referred to as a “call function Y.”

In step S406, the call graph creation unit 14 identifies one or more classes in which a function which can be actually called (at the time of executing the target program) according to calling of the call function Y. That is, a function defined by the class identified in step S406 among functions having the same name as the call function Y is a function likely to be actually called from the processing target function Y. Note that the detail of step S406 will be described later.

Subsequently, the call graph creation unit 14 adds an edge to the call function Y of each class identified in step S406 from the processing target function X to the call graph (S407). At this time, if there is no node on the leading side of the edge (node corresponding to the call function Y), the call graph creation unit 14 also creates the node.

Subsequently, the call graph creation unit 14 adds the call function Y to the processing target function list in order to recursively process a function further called from the call function Y (S408).

When loop processing L2 ends, the call graph creation unit 14 executes loop processing L1 for a call function newly added to the processing target function list.

When loop processing L1 ends (that is, when the processing target list becomes vacant), the call graph creation unit 14 outputs the call graph (S409). When a plurality of call graph entry points are input, a plurality of call graphs may be output.

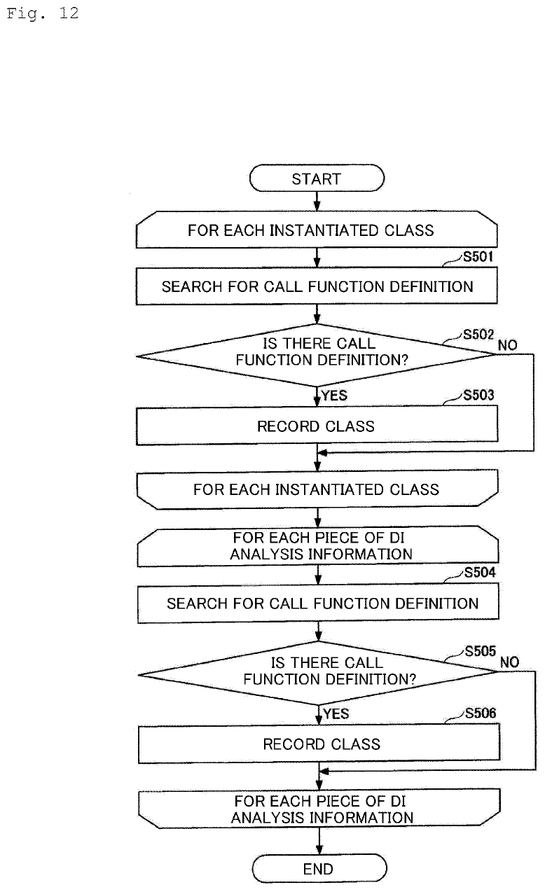

Subsequently, step S406 will be described in detail. FIG. 12 is a flowchart illustrating an example of a processing procedure of class identification processing.

The call graph creation unit 14 searches for the definition of the call function Y from respective definitions of classes included in a list of instantiated classes extracted in step S404 in FIG. 11 (S501), and if there is a class including the definition (S502), records the class identifier of the class in, for example, the memory device 103 or the auxiliary storage device 102 (S503). That is, the class is identified as a class in which a function which can be actually called (at the time of executing the target program) according to calling of the calling function Y is defined.

Subsequently, the call graph creation unit 14 searches for the definition of the call function Y in the definition of a class relating to each class identifier included in the DI analysis information list (S504), and if there is a class including the definition (YES in S505), records the class identifier of the class in, for example, the memory device 103 or the auxiliary storage device 102 (S506). That is, the class is identified as a class in which a function which can be actually called (at the time of executing the target program) according to calling of the calling function Y is defined. When the class identifier that is a recording target in step S506 has already been recorded in step S503, the class identifier may not be recorded in step S506.

As described above, according to the present embodiment, it is possible to statically acquire information on a class instantiated using a dynamic function such as reflection according to a library having the DI function in advance and use the information at the time of creating a call graph. Therefore, it is possible to create a call graph with high accuracy even for a program implemented using DI which cannot be handled by conventional technology. That is, according to the present embodiment, call graph creation accuracy can be improved.

It is possible to perform more accurate determination by utilizing a call graph created using the present embodiment for, for example, technology for determining the influence of vulnerability of a library on an application using a call graph (for example, “S. E. Ponta, H. Plate and A. Sabetta, “Beyond Metadata: Code-Centric and Usage-Based Analysis of Known Vulnerabilities in Open-Source Software,” 2018 IEEE International Conference on Software Maintenance and Evolution (ICSME)”).

Note that in the present embodiment, the processing target function X is an example of a first function. The call function Y is an example of a second function. The call graph creation unit 14 is an example of a first identification unit, a second identification unit, and a creation unit. The DI setting file analysis unit 11 is an example of a first analysis unit. The DI annotation analysis unit 12 is an example of a second analysis unit. The DI definition function analysis unit 13 is an example of a third analysis unit.

Although the embodiments of the present invention have been described in detail above, the present invention is not limited to these particular embodiments, and various modifications and changes are possible within the scope of the gist of the present invention described in the claims.

### REFERENCE SIGNS LIST

10 Call graph creation apparatus
11 DI setting file analysis unit
12 DI annotation analysis unit
13 DI definition function analysis unit
14 Call graph creation unit
100 Drive device
101 Recording medium
102 Auxiliary storage device
103 Memory device
104 CPU
105 Interface device
B Bus

1. A call graph creation apparatus comprising:
a processor; and
a memory storing program instructions that cause the processor to
analyze a definition of a first function included in a certain program and identify a list of classes instantiated in the first function and a list of second functions called by the first function;
identify, for each of the second functions, a class including a definition of the second function from the list of the classes; and
set each of the first function and the second functions as a node and generate a call graph including an edge from a node of the first function to a node of each second function.

2. The call graph creation apparatus according to claim 1, wherein the processor is further configured to
analyze a DI setting file and identify a list of classes instantiated by a library having a DI function, and
identify, for each of the second functions, a class including a definition of the second function from the identified list of classes.

3. The call graph creation apparatus according to claim 1, wherein the processor is further configured to
analyze source code of the certain program and identify a list of classes to which a DI annotation has been applied in the DI setting file among classes included in the certain program, and
identify, for each of the second functions, a class including the definition of the second function from the identified list of classes.

4. The call graph creation apparatus according to claim 1, wherein the processor is further configured to
analyze definitions of functions included in the certain program and identify a class instantiated by a library having a DI function, and
identify, for each of the second functions, a class including the definition of the second function from the identified list of classes.

5. A call graph creation method performed by a computer, the method comprising:
analyzing a definition of a first function included in a certain program and identifying a list of classes instantiated in the first function and a list of second functions called by the first function;
identifying, for each of the second functions, a class including a definition of the second function from the list of the classes; and
setting each of the first function and the second functions as a node and generating a call graph including an edge from a node of the first function to a node of each second function.

6. A non-transitory computer-readable recording medium storing a program causing a computer to serve as the call graph creation apparatus according to claim 1.
